(19) United States
(12) Patent Application Publication
(10) Pub. No.: US 2010/0049655 A1
(43) Pub. Date: Feb. 25, 2010

(54) METHOD AND SYSTEM FOR SECURELY EXECUTING A CHARGE TRANSACTION

(75) Inventors: David Nilsson, Helsingborg (SE); Michael Jorgensen, Ramlosa (SE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SMARTREFILL I HELSINGBORG AB, Helsingborg (SE)

(21) Appl. No.: 12/523,575

(22) PCT Filed: Jan. 16, 2008
(86) PCT No.: PCT/SE08/00030

§ 371 Date: Jul. 17, 2009

Related U.S. Application Data
(60) Provisional application No. 60/897,652, filed on Jan. 26, 2007.

(30) Foreign Application Priority Data
Jan. 26, 2007 (SE) 0700224-9

(51) Int. Cl. G06Q 20/00; H04L 9/12

(52) U.S. Cl. 705/44; 713/150

(57) ABSTRACT

A method for securely executing a charge transaction establishes an encrypted communication link between the mobile telecommunication device and a host by utilizing executable program code in the mobile telecommunication device. The method transmits data related to a charge transaction request from the host to the mobile telecommunication device via the encrypted communication link, and further transmits a second of at least two in combination unique data sets from the mobile telecommunication device to the host via the encrypted communication link as authorization for the charge transaction to be executed, and even further transmits from the host to a payment service provider, data related to the charge transaction request, the received second data set and a, in combination with the received second data set unique first data set stored at the host. The method completes the charge transaction if the first and second data sets in combination authorize the charge transaction.

### TECHNICAL FIELD

The present invention generally relates to mobile telecommunication devices and more specifically to a method, apparatus and system for enabling secure transmission of confidential information from a mobile telecommunication device to a host, e.g. when transferring money from a user account to another party.

### BACKGROUND OF THE INVENTION

The use of credit cards when purchasing goods has increased steadily during the last years. The benefits from using a credit card instead of bills and coins are many, among which the security for the parts involved in the transaction may be the most striking. However, the use of credit cards for performing financial transactions is not completely problem-free. For example skimming, where the data in the credit card's magnetic strip is copied to a duplicate card without the card owner's knowledge is an increasing problem. Additionally, a person who wants to use a credit card must at the time of purchase present the actual card to the seller for use in a terminal mounted in e.g. the store where the purchase takes place. This implies that the credit card may be lost or stolen when carried along to the place of purchase.

Today the use of mobile telecommunication technologies in various forms is widespread and many people are in the possession of a mobile telecommunication device, such as a mobile telephone, a personal digital assistant (PDA) or a computer with networking capabilities. Even though the main idea of using mobile telecommunications systems initially was to arrange telephone calls, such systems today provide for many other applications, such as message transfer (e.g. email, short messaging service, SMS) or multimedia transfer (e.g. multimedia messaging service, MMS) or network access (e.g. internet browsing).

In relation to the increased use of mobile telecommunication devices, many different methods and systems for debiting users of the systems have been proposed. One such system is to use so called pre-paid telephone cards, wherein a user of the system may purchase a certificate equivalent to a certain amount of money which is registered to the pre-paid telephone card. The user may then use the money for placing telephone calls (i.e. normally pay for the amount of time the telephone calls are established) or accessing available networks (i.e. normally pay for the amount of data transferred). One problem in relation to pre-paid telephone cards is that the user of the mobile telephone must be able to top-up the card in order to be able to place telephone calls.

### SUMMARY OF THE INVENTION

According to a first aspect, the present invention is realized by a method for enabling secure transmittal of data from a mobile telecommunication device to a host. The method comprises: transmitting a message from the mobile telecommunication device to the host requesting registration with the host, transmitting executable program code from the host to the mobile telecommunication device, said program code being arranged to establish an encrypted communication link between the mobile telecommunication device and the host when executed in the mobile telecommunication device, executing the received program code in the mobile telecommunication device such that an encrypted communication link is established between the mobile telecommunication device and the host, transmitting, from the mobile telecommunication device, a first of at least two in combination unique data sets to the host via the encrypted communication link, determining, at the host, if the first data set corresponds to a valid account number, and if the determination is positive, storing the account number and transmitting an acknowledge signal to the mobile telecommunication device, indicating the positive outcome of the determination, and deleting the first data set in the mobile telecommunication device in response to receiving the acknowledge signal. An advantage is that the mobile telecommunication device transmits only a first of at least two in combination unique data sets to the host via the encrypted communication link. In case the communication link, despite the encryption, is tapped by a fraudulent user, not all information needed for establishing a unique set will be available. Moreover it is beneficial to transmit the executable program code from the host to the mobile telecommunication device as it ensures that the program is not provided by a fraudulent person.

The method may comprise that the message is transmitted from the mobile telecommunication device. An advantage with this embodiment is that the initiation of the registration is always controlled by the user of the mobile telecommunication device.

The method may comprise that the message is transmitted from a client connected to the host. An advantage with this embodiment is that the initiation of the registration may be performed remotely by an authorized user.

The method may further comprise receiving, in the mobile telecommunication device, user input data comprising the first of at least two in combination unique data sets. An advantage with this embodiment is that the user of the mobile telecommunication device may, when requesting registration, always supervise which data that is provided to the host.

The method may further comprise that the first data set comprises a credit card number. An advantage with this embodiment is that the frame work for transferring money is established according to world wide standards making it easy to implement the invention almost anywhere in the world.

The method may further comprise that the first data set comprises information identifying the source of the first data set. An advantage with this embodiment is that it facilitates the identification of the device providing the first data set making it harder to utilize the invention for fraudulent purposes.

The method may further comprise that the host, when determining if the first data set corresponds to a valid account number, receives data from a third party, such as a financial institution. An advantage with this embodiment is that the security of the system is improved since the information needed for determining if the first data set is a valid account number is not provided by the host only.

The method may further comprise that the message transmitted from the mobile telecommunication device is transmitted by means of sms, mms or email. An advantage with this embodiment is that the frame work for transferring money is established according to world wide standards making it easy to implement the invention almost anywhere in the world.

The method may further comprise that the program code received in the mobile telecommunication device is a java program. An advantage with this embodiment is that the program code is less platform dependent, wherein the invention may easily be implemented in mobile telecommunication devices using different operating systems.

According to a second aspect, the present invention is realised by a system for enabling secure transmittal of data from a mobile telecommunication device to a host, said system comprising: means for transmitting a message to the host requesting registration with the host, the host being arranged to transmit executable program code from the host to the mobile telecommunication device, said program code being arranged to establish an encrypted communication link between the mobile telecommunication device and the host when executed in the mobile telecommunication device, the mobile telecommunication device being arranged to execute the received program code such that an encrypted communication link is established between the mobile telecommunication device and the host, the mobile telecommunication device being arranged to transmit a first of at least two in combination unique data sets to the host via the encrypted communication link, the host being arranged to determine if the first data set corresponds to a valid account number, and if the determination is positive, store the account number and transmit an acknowledge signal to the mobile telecommunication device, indicating the positive outcome of the determination, the mobile telecommunication device being arranged to delete the first data set in the mobile telecommunication device in response to receiving the acknowledge signal.

According to a third aspect, the invention is realized by a method for securely executing a charge transaction by means of a mobile telecommunication device, said method comprising: establishing an encrypted communication link between the mobile telecommunication device and a host by utilizing executable program code in the mobile telecommunication device, said program code being arranged to establish an encrypted communication link between the mobile telecommunication device and the host when executed in the mobile telecommunication device, transmitting data related to a charge transaction request from the host to the mobile telecommunication device via the encrypted communication link, transmitting a second of at least two in combination unique data sets from the mobile telecommunication device to the host via the encrypted communication link as authorization for the charge transaction to be executed, transmitting, from the host to a payment service provider, data related to the charge transaction request, the received second data set and a, in combination with the received second data set unique first data set stored at the host, and completing the charge transaction if the first and second data sets in combination authorize the charge transaction. An advantage is that the mobile telecommunication device transmits only a second of at least two in combination unique data sets to the host via the encrypted communication link. In case the communication link, despite the encryption, is tapped by a fraudulent user, not all information needed for establishing a unique set will be available.

The method may further comprise that the establishing of the encrypted communication link is initiated by a message from the host. An advantage with this embodiment is that the establishing of the encrypted link is always controlled by the host ensuring that no fraudulent person gains access to the information in the mobile telecommunication device.

The method may further comprise that the establishing of the encrypted communication link is initiated by a message from the mobile telecommunication device. An advantage with this embodiment is that the user of the mobile telecommunication device may always safeguard that no fraudulent person may initiate unauthorized access to the mobile telecommunication device.

The method may further comprise that the second data set corresponds to a PIN code. An advantage with this embodiment is that the second data set is in a form which is only known to the user of the mobile telecommunication device thereby increasing the security of the system.

The method may further comprise that the first data set corresponds to a credit card number. An advantage with this embodiment is that the frame work for transferring money is established according to world wide standards making it easy to implement the invention almost anywhere in the world.

The method may further comprise that the completion of the charge transaction comprises transferring funds from the credit card account to a business or an individual. An advantage with this embodiment is that the purchase of goods and services is facilitated without the need for specific money-transfer equipment at the location where the purchase is performed

The method may further comprise that the business is a mobile network operator and that the host verifies with the mobile network operator that the mobile telecommunication device is a registered subscriber of services from the mobile network operator. An advantage with this embodiment is that only relevant attempts to e.g. refill a prepaid telephone card are executed.

According to a fourth aspect, the present invention is realised by a system for securely executing a charge transaction by means of a mobile telecommunication device, said system comprising: the mobile telecommunication device being arranged to establish an encrypted communication link between the mobile telecommunication device and a host by utilizing executable program code, said program code being arranged to establish an encrypted communication link between the mobile telecommunication device and the host when executed in the mobile telecommunication device, the host being arranged to transmit data related to a charge transaction request to the mobile telecommunication device via the encrypted communication link, the mobile telecommunication device being arranged to transmit a second of at least two in combination unique data sets to the host via the encrypted communication link as authorization for the charge transaction to be executed, the host being arranged to transmit, to a payment service provider, data related to the charge transaction request, the received second data set and a, in combination with the received second data set unique first data set stored at the host, and means for completing the charge transaction if the first and second data sets in combination authorize the charge transaction.

Other objectives, features and advantages of the present invention will appear from the following detailed disclosure, from the attached claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 diagrammatically illustrates a system in which the present invention may be used;

FIG. 2 is a more detailed view of the system in FIG. 1;

FIG. 3 is a schematic block diagram of a method according to a first aspect of the present invention;

FIG. 4 is a schematic block diagram of a method according to a second aspect of the present invention;

### DETAILED DESCRIPTION OF PREFERRED EMBODIMENTS

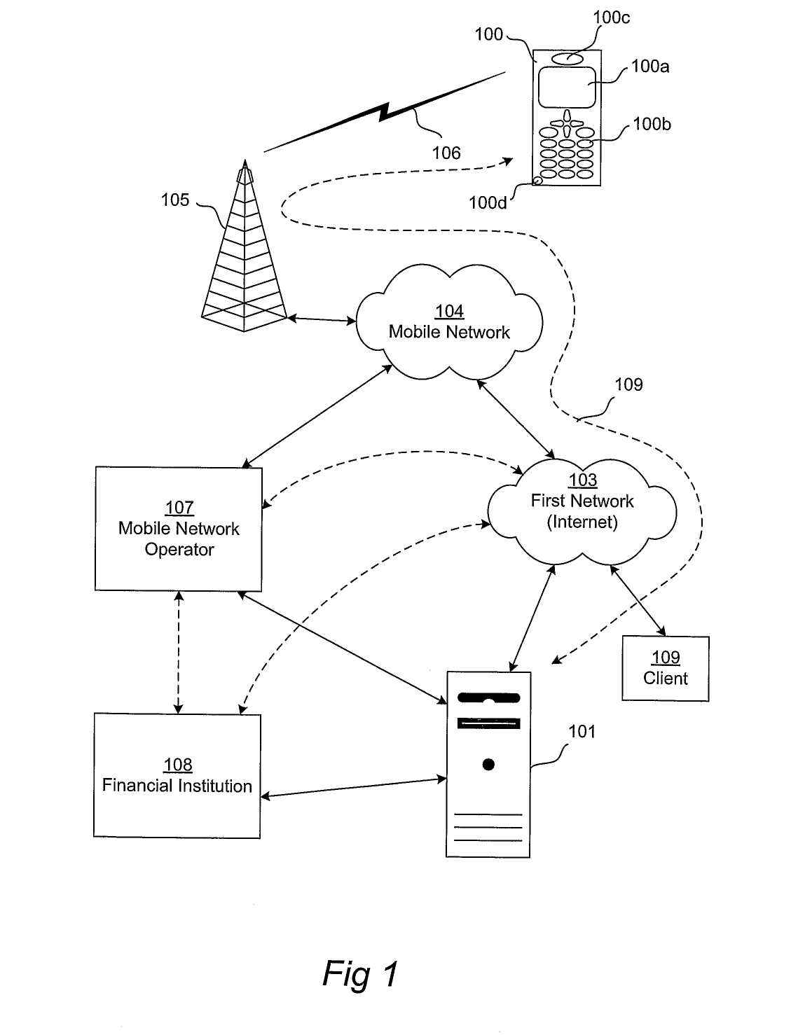

FIG. 1 illustrates a system according to first aspect of the present invention. In the system of FIG. 1, a mobile telecommunication device 100 communicates with a host 101 by means of different networks 103 and 104. More specifically, data may be transferred from the host 101 via a first network 103 such as the Internet or a LAN, a mobile network 104 such as such as GSM, UMTS, D-AMPS or CDMA2000, a base station 105 thereof across a wireless communication link 106 to the mobile telecommunication device 100, and vice versa.

The mobile telecommunication device 100 preferably comprises a display 100a for presenting visual data to a user of the mobile telecommunication device 100, a keyboard 100b for receiving typed input data from the user, a loudspeaker 100c for providing audio data to the user, and a microphone 100d for receiving audio input from the user.

Moreover, the system includes a mobile network operator 107 which is connected to the host 101 and the mobile network 104. The main task of the mobile operator 107 is to provide services to the user of the mobile telecommunication device 100, e.g. voice communication, fax, messaging services, email and data calls.

As will be discussed in more detail below, the system may also include one or more financial institutions 108, such as a payment service provider 108, which are connected to the host 101. The mobile network operator 107 may also be connected to the financial institution 108, e.g. via the mobile telecommunication network 104 and the first network 103 or via the first network 103 only (indicated by the dashed line in FIG. 1). Alternatively, the mobile network operator 107 may be connected directly to the financial institution 108 by means of e.g. the Public Switched Telephone Network (not shown).

The system may also include a client 109 which is connected to the host 101 via the first network 103. The client 109 may be used for sending commands to the host 101. An example of a command that may be transferred from the client 109 to the host 101 is a command to initiate establishing of a communication link between the host 101 and the mobile telecommunication device 100.

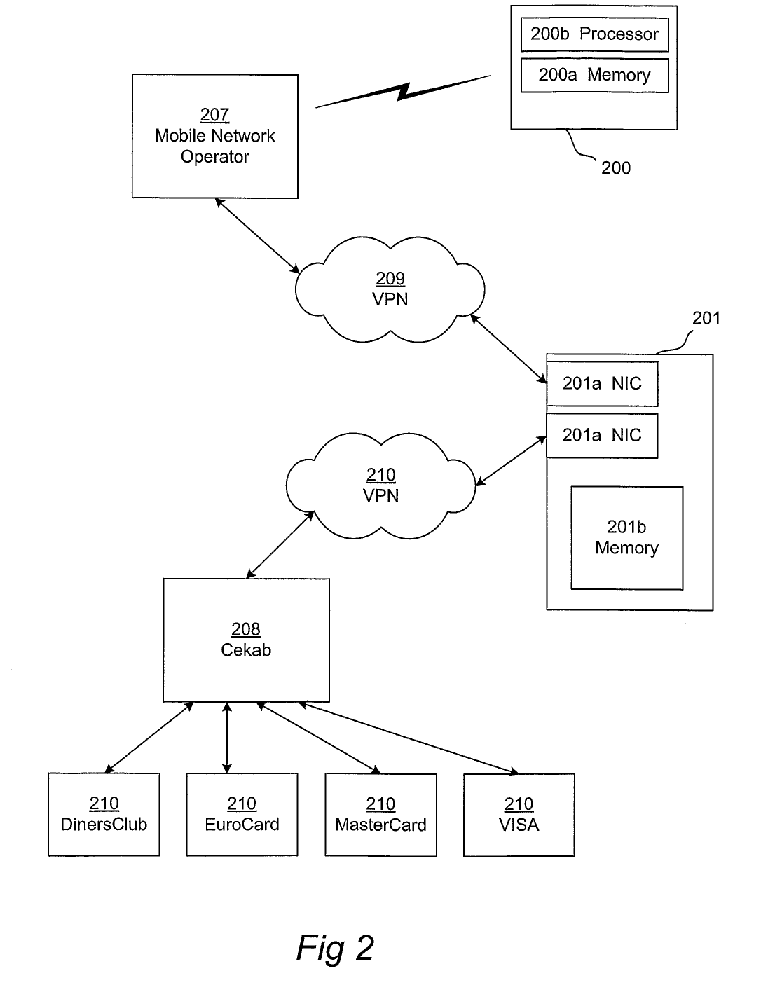

In a preferred embodiment, shown in FIG. 2, both the mobile network operator 207 and the financial institution 208 communicate with the host 201 by means of a respective virtual private network (VPN) 209, 210. For the sake of simplicity only one mobile network operator 207 is shown in FIG. 2. However, it is emphasized that one or more different operators may be connected to the host 201. The financial institution 208 may be a centralized payment service provider for electronic card transactions such as CEKAB (Centralen För Elektroniska Korttransaktioner Aktiebolag), BOX 5212, SE-121 18, Johanneshov, Sweden, which is a Swedish service provider for distributing transactions to a number of card or bank institutions, such as VISA 210, Master Card 211, Euro Card 212 or Diners Club 213. In the scope of the present invention, additional financial institutions (not shown) may also be in communication with the host. The host 201 comprises means 201a, in the form of one or more network interfaces cards, for communication with other parts of the system. The network interfaces 201a may be adapted for wireless communication or for communication by means of cables. The host 210 moreover comprises a memory 201b for storing (possibly temporarily) e.g. credit card numbers, PIN codes and executable program code. The memory 201b is in communication with the network interface 201a making it possible to transfer information to/from the memory from/to the other parts of the system.

The mobile telecommunication device 200 comprises a memory 200a for e.g. storing information received via the mobile network operator (via a base station). Additionally, the memory 200a may be used for storing information received from e.g. a personal computer via e.g. a USB-port, a Bluetooth link or an infrared link. In particular, the memory 200a may be used for storing executable program code received from the host 201. The executable program code may then be executed by means of a processor 200b connected to the memory 200a.

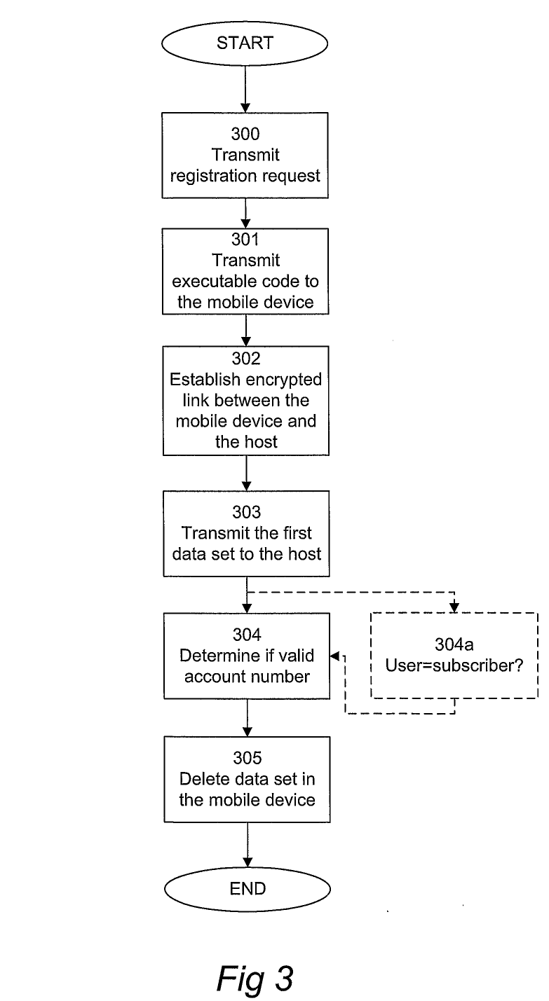

With reference to FIG. 3 a method according to a first aspect of the present invention will be disclosed. More specifically, FIG. 3 discloses a method for enabling secure transmittal of data from a mobile telecommunication device to a host. The data transmitted from the mobile telecommunication device 100 to the host 101 may relate to user account data such as a user's credit card number and a PIN code for authorizing the same.

In step 300 the mobile telecommunication device 100 transmits a message from the mobile telecommunication device 100 to the host 101 requesting registration with the host 101. The message may be transmitted by means of sms, mms, email, wap, or any other suitable data transfer technology. The message is preferably transferred from the mobile telecommunication device 100 via the base station 105, the mobile network 104 and the first network 103 (e.g. the Internet) to the host 101. Alternatively, the host 101 may be directly connected to the mobile network 104 by means of a radio transceiver (not shown), wherein the first network 103 becomes superfluous. Alternatively, a client 109 may transmit the message to the host 101 via the first network 103. A user of the system may hence request registration for the mobile telecommunication device 100 with the host 101 by using the client 103 only.

In reply to the registration request transmitted from the mobile telecommunication device 100 in step 300, the host 101, in step 301, transmits executable program code to the mobile telecommunication device 101. The transmitted program code is arranged to establish an encrypted communication link between the mobile telecommunication device 100 and the host 101. The encrypted communication link is indicated by a dashed line 109 in FIG. 1. The executable program code may be in the form of Java from Sun Microsystems, Inc. or any other format suitable for transmission via the mobile network 104.

In step 302 a processing device 200b in the mobile telecommunication device 100 executes the received program code such that an encrypted communication link is established between the mobile telecommunication device 100 and the host 101. The encrypted communication link may, as mentioned above, be established by means of a secure VPN which uses cryptographic tunneling protocols to prohibit unauthorized access to the data transmitted between the mobile telecommunication device 100 and the host 101. By the use of tunneling protocols, the routing nodes in any public network, such as the mobile network 104 and the first network 103 are unaware that the transmission is part of a private network. The data transmitted through the “tunnel” is not available to anyone on the public network without authorization to access the VPN. Secure VPN protocols available today include: IPsec (IP security), SSL/TLS, PPTP (Point-to-Point Tunneling Protocol), L2TP (Layer 2 Tunneling Protocol), L2TPv3 (Layer 2 Tunneling Protocol version 3) and VPN-Q.

In step 303 the mobile telecommunication device 100 transmits a first of at least two in combination unique data sets to the host 101 via the encrypted communication link. In the embodiments disclosed herein, for reasons of simplicity, the first data set corresponds to a credit card number which a user of the mobile telecommunication device 100 has entered into the mobile telecommunication device 100 by means of e.g. the keyboard 100b arranged on the device 100. However, a skilled person realizes that the first data set may alternatively correspond to a bank account number, a user account number or any other form of information which together with a second data set, such as a PIN code, uniquely identify and authorize a user of the system. The user of the mobile telecommunication device 100 may enter the first data set as a result of an invitation from the received and executed program which is running on the mobile telecommunication device 100. The invitation to enter the first data set may alternatively be provided by the host 101 and transmitted to the mobile telecommunication device 100 via the encrypted communication link 109.

The first data set may also be provided from the user to the mobile telecommunication device 100 by means of voice data via the microphone 100d. In this case the user of the mobile telecommunication device 100 may initially be connected to the host, and from the host receive audio or visual instructions to pronounce the digits and/or characters of the credit card number, which are then subsequently transmitted to the host 101. Software at the host may then interpret the received voice data and convert it to digital data corresponding to the credit card number.

In addition to the account number, the first data set may also comprise information identifying the source of the first data set. This information may for example be in the form of a telephone number of the mobile telecommunication device, an International Mobile Equipment Identity (IMEI) number associated with the mobile telecommunication device 100 or an International Mobile Subscriber Identity (IMSI) number associated with the subscriber of services in the mobile telecommunication system.

In step 304 the host 101 determines if the received credit card number corresponds to a valid credit card number. The determination may be done by correlating the received number with an database internal to the host 101 or by accessing an external database provided by a financial institution such as CEKAB mentioned above. If the host 101 determines that the received credit card number corresponds to a valid credit card number, the host 101 stores the credit card number in a database and transmits an acknowledge signal to the mobile telecommunication device 101 indicating the positive outcome of the determination. In case the first data set also comprises identification data identifying the source of the first data set as disclosed above, the host 101 may store the identification data together with the credit card number in the data base.

In step 305 the mobile telecommunication device 100 deletes the credit card number received in the mobile telecommunication device 100 in response to receiving the acknowledge signal. The number is then present only at the host 101.

The above method may advantageously be used in combination with pre-paid telephone cards. In this case the host 101 in step 304a additionally verifies with the mobile network operator 107 that the user is a registered subscriber of services from the mobile network operator.

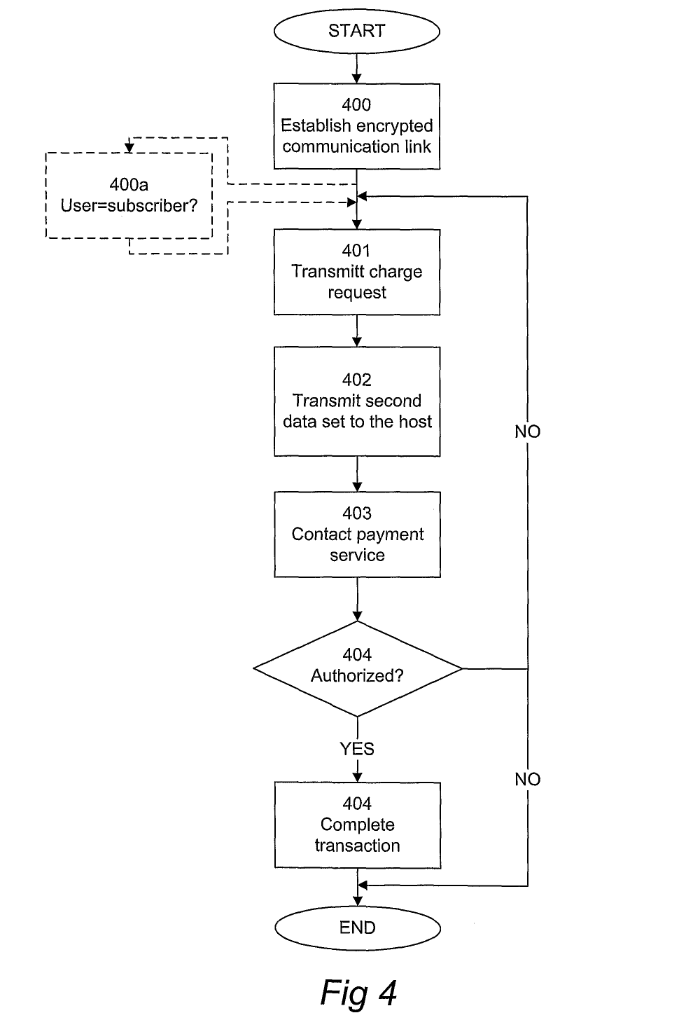

With reference to FIG. 4 a method according to a second aspect of the present invention will be disclosed. More specifically, FIG. 4 discloses a method for securely executing a charge transaction by means of a mobile telecommunication device. In the example below, a secure charge transaction from a user's credit card to a business in relation to a purchase from the business will be disclosed. However, it is understood that the transaction may as well be done to an account of an individual instead of to a business. For reasons of simplicity, only the transaction to a business will be disclosed, but the same principles applies when transferring money to an individual. In one embodiment, the business is registered as a user at the host 101, wherein the host 101 receives information relating to bank or credit accounts for the business and stores the information in a database connected to the host. Together with an authorization from the business, this information may then be used for transferring money to or from the business account.

In step 400 an encrypted communication link 109 is established between the mobile telecommunication device 100 and the host 101 by utilizing executable program code in the mobile telecommunication device 100. The communication link 109 may be established as described in relation to FIG. 3 above and will not be disclosed in detail below.

In step 401 the host transmits data related to a charge request to the mobile telecommunication device via the encrypted communication link. The data related to the charge request may be in the form of a transaction number, or some other form of identifier, and the amount to transfer, e.g. “Transfer $25 to Business X, Ok?” or “Transaction #1234, $25, pay now?”. It is understood the charge transaction request may include additional information for internal use by the host 101 and the business and that all information related to the charge request need not be transmitted to and/or shown at the mobile telecommunication device 100. Such information may be e.g. time limit during which the charge transaction request is valid, check sums for ensuring that the charge transaction request is transferred without problems, digital certificates for validating the business as receiver of the payment, etc. The charge transaction request is preferably presented on the display 100a in the mobile telecommunication device 100. A user of the mobile telecommunication device 100 may then authorize the transaction by entering e.g. a PIN code by typing the PIN code on the keyboard 100b or providing the PIN code in the form of audio data as spoken words via the microphone 100d. Alternatively, the charge request may be presented as spoken words to the user of the mobile telecommunication device 100 by means of the loudspeaker 100c, wherein the user may authorize the transaction by providing the PIN code by either using the keyboard 100b or the microphone 100d.

In step 402 the host transmits a second of at least two in combination unique data sets from the mobile telecommunication device 100 to the host 101 via the encrypted communication link as authorization for the charge transaction to be executed. The second data set may be in the form of a PIN code which in combination with the previously transmitted credit card number authorizes the host 101 to transfer money from the credit card to the business. Alternatively, in similarity with the disclosure above, the second data set may be provided to a user of the mobile telecommunication device 100 in the form of audio data via the loudspeaker 100c. The user may then enter the PIN code by pressing the correct keys on the keyboard 100b or providing the PIN code in the form of audio data as spoken words via the microphone 100d.

In step 403 the host 101 transmits data related to the charge request to a financial institution such as a payment service provider 108. The charge request is transmitted to the payment service provider 108 together with the received second data set and a, in combination with the received second data set unique first data set stored at the host 101. The charge request comprises inter alia information about the amount of money to transfer from the credit card. Together with the credit card number and the PIN code all information necessary for authorizing a transaction of money from the credit card to the business is provided to the payment service provider 108. It is emphasized in this context that the charge request may include the first and second data set or that the first and second data set may be transmitted to the payment service provider 108 as separate components of the message to the payment service provider 108.

As mentioned above in relation to FIG. 2, the communication link between the host 101 and the payment service provider 208 may be in the form of a VPN, wherein the data transmitted between the two units are protected from unauthorized access. Additionally, the host 101 may store the PIN code in a memory thereof for subsequent use, or the host 101 may directly transfer the PIN code to the financial institution without storing the PIN code (besides temporary storage in transfer registers as realized by the skilled person).

In step 404 the charge transaction is completed if the first and second data sets in combination authorize the transaction. The transaction may be done by transferring money to an account which the operator of the host 101 has registered with the payment service provider 108. The operator of the host may then subsequently transfer the money to the business. By this procedure the business need not to register an account with the payment service provider 108. Alternatively, the business is registered with the payment service 108, wherein the charge transaction request comprises information about the business' registered account so that the transaction may be completed without transferring the money to the host 101.

In case the transaction is not authorized, i.e. the PIN code, the account number or any other relevant information is erroneous, the transaction is not completed and the routine either ends or returns to step 401, wherein a new charge request is transmitted to the mobile telecommunication device 100.

The above method may advantageously be used in combination with pre-paid telephone cards. In this case the host 101 in step 400a additionally verifies with the mobile network operator 107 that the user of the mobile telecommunication device 100 is a registered subscriber of services from the mobile network operator. Money transferred from the credit card is then received at the mobile network operator. Alternatively, the operator of the host 101 may in advance purchase licenses corresponding to units of phone time from the mobile network operator 107. The payment is then received at the host, wherein the host 101 informs the mobile network operator 107 to update the available phone time for the user of the mobile telecommunication device 100.

The invention has mainly been described above with reference to a few embodiments. However, as is readily appreciated by a person skilled in the art, other embodiments than the ones disclosed above are equally possible within the scope of the invention, as defined by the appended patent claims.

1. A method for enabling secure transmittal of data from a mobile telecommunication device to a host, said method comprising:
transmitting a message to the host requesting registration with the host,
transmitting executable program code from the host to the mobile telecommunication device, said program code being arranged to establish an encrypted communication link between the mobile telecommunication device and the host when executed in the mobile telecommunication device,
executing the received program code in the mobile telecommunication device such that an encrypted communication link is established between the mobile telecommunication device and the host,
transmitting, from the mobile telecommunication device, among at least two in combination unique data sets, only a first of said data sets, to the host via the encrypted communication link,
determining, at the host, if the first data set corresponds to a valid account number, and if the determination is positive, storing the account number and transmitting an acknowledge signal to the mobile telecommunication device, indicating the positive outcome of the determination, and
deleting the first data set in the mobile telecommunication device in response to receiving the acknowledge signal.

2. The method according to claim 1, wherein the message is transmitted from the mobile telecommunication device.

3. The method according to claim 1, wherein the message is transmitted from a client connected to the host.

4. The method according to claim 1, comprising receiving, in the mobile telecommunication device, user input data comprising the first of at least two in combination unique data sets.

5. The method according to claim 1, wherein the first data set comprises a credit card number.

6. The method according to claim 1, wherein the first data set comprises information identifying the source of the first data set.

7. The method according to claim 1, wherein the host, when determining if the first data set corresponds to a valid account number, receives data from a third party, such as a financial institution.

8. The method according to claim 1, wherein the message transmitted from the mobile telecommunication device is transmitted by means of sms, mms or email.

9. The method according to claim 1, wherein the program code received in the mobile telecommunication device is a java program.

10. A method for securely executing a charge transaction by means of a mobile telecommunication device, said method comprising:
establishing an encrypted communication link between the mobile telecommunication device and a host by utilizing executable program code in the mobile telecommunication device, said program code being arranged to establish an encrypted communication link between the mobile telecommunication device and the host when executed in the mobile telecommunication device,
transmitting data related to a charge transaction request from the host to the mobile telecommunication device via the encrypted communication link,
transmitting, among at least two in combination unique data sets, only a second of said data sets, from the mobile telecommunication device to the host via the encrypted communication link as authorization for the charge transaction to be executed,
transmitting, from the host to a payment service provider, data related to the charge transaction request, the received second data set and a, in combination with the received second data set unique first data set stored at the host, and completing the charge transaction if the first and second data sets in combination authorize the charge transaction.

11. The method according to claim 10, wherein the establishing of the encrypted communication link is initiated by a message from the host.

12. The method according to claim 10, wherein the establishing of the encrypted communication link is initiated by a message from the mobile telecommunication device.

13. The method according to claim 10, wherein the second data set corresponds to a PIN code.

14. The method according to claim 10, wherein the first data set corresponds to a credit card number.

15. The method according to claim 10, wherein the completion of the charge transaction comprises transferring funds from the credit card account to a business or an individual.

16. The method according to claim 15, wherein the business is a mobile network operator and that the host verifies with the mobile network operator that the mobile telecommunication device is a registered subscriber of services from the mobile network operator.

17. A system for enabling secure transmittal of data from a mobile telecommunication device to a host, said system comprising:
a transmitter configured to transmit a message to the host requesting registration with the host,
the host being arranged to transmit executable program code from the host to the mobile telecommunication device, said program code being arranged to establish an encrypted communication link between the mobile telecommunication device and the host when executed in the mobile telecommunication device,
the mobile telecommunication device being arranged to execute the received program code such that an encrypted communication link is established between the mobile telecommunication device and the host,
the mobile telecommunication device being arranged to transmit among at least two in combination unique data sets, only a first of said data sets, to the host via the encrypted communication link,
the host being arranged to determine if the first data set corresponds to a valid account number, and if the determination is positive, store the account number and transmit an acknowledge signal to the mobile telecommunication device, indicating the positive outcome of the determination, and
the mobile telecommunication device being arranged to delete the first data set in the mobile telecommunication device in response to receiving the acknowledge signal.

18. The system according to claim 17, wherein the mobile telecommunication device is arranged to transmit the message.

19. The system according to claim 17, wherein the a client connected to the host is arranged to transmit the message.

20. The system according to claim 17, wherein the mobile telecommunication device is arranged to receive user input data comprising the first of at least two in combination unique data sets.

21. The system according to claim 17, wherein the first data set comprises a credit card number.

22. The system according to claim 17, wherein the first data set comprises information identifying the source of the first data set.

23. The system according to claim 17, wherein the host is arranged to, when determining if the first data set corresponds to a valid account number, receive data from a third party, such as a financial institution.

24. A system for securely executing a charge transaction by means of a mobile telecommunication device, said system comprising:
the mobile telecommunication device being arranged to establish an encrypted communication link between the mobile telecommunication device and a host by utilizing executable program code, said program code being arranged to establish an encrypted communication link between the mobile telecommunication device and the host when executed in the mobile telecommunication device,
the host being arranged to transmit data related to a charge transaction request to the mobile telecommunication device via the encrypted communication link,
the mobile telecommunication device being arranged to transmit among at least two in combination unique data sets, only a second of said data sets, to the host via the encrypted communication link as authorization for the charge transaction to be executed,
the host being arranged to transmit, to a payment service provider, data related to the charge transaction request, the received second data set and a, in combination with the received second data set unique first data set stored at the host, and
wherein the charge transaction is completed if the first and second data sets in combination authorize the charge transaction.

25. The system according to claim 24, wherein the host is arranged to initiate the establishing of the encrypted communication link.

26. The system according to claim 24, wherein the mobile telecommunication device is arranged to initiate the establishing of the encrypted communication link.

27. The system according to claim 24, wherein the second data set corresponds to a PIN code.

28. The system according to claim 24, wherein the first data set corresponds to a credit card number.

29. The system according to claim 24, wherein the means for completing the charge transaction is arranged to transfer funds from the credit card account to a business or an individual.

30. The method according to claim 29, wherein the business is a mobile network operator and that the host verifies with the mobile network operator that the mobile telecommunication device is a registered subscriber of services from the mobile network operator.
